(19) United States
(12) Patent Application Publication
(10) Pub. No.: US 2003/0167362 A1
(43) Pub. Date: Sep. 4, 2003

(54) Portable recording device

(76) Inventor: Jean-Pierre Beauviala, Grenoble (FR)

Correspondence Address: DUANE MORRIS LLP, 100 COLLEGE ROAD WEST, SUITE 100, PRINCETON, NJ, 08540-6604, US

(21) Appl. No.: 10/345,615

(22) Filed: Jan. 16, 2003

(30) Foreign Application Priority Data
Jan. 17, 2002 (FR) 02/00546

(51) Int. Cl. G06F 13/12

(52) U.S. Cl. 710/72

(57) ABSTRACT

A portable sound or image recording device comprising: a body comprising recording elements, control elements and input-output sockets; two legs each formed of an element for supplying the device, said legs being removably assembled by means of damping elements on said body in the vicinity of its ends to define a portico; and a package laterally framed by the respective legs and intended to contain at least one digital storage support with a mobile part, the height and the width of the legs being such that the package inscribes within said portico.

### BACKGROUND OF THE INVENTION

1. Field of the Invention

The present invention generally relates to portable sound and/or image recording devices. The present invention more specifically relates to devices in which the images and/or the sound are stored on a digital storage device.

2. Discussion of the Related Art

The present invention will be described hereafter in relation with a portable sound recorder, the recording support of which is a hard disk or the like. It should however be noted that it more generally applies to any portable device of sound recorder or video recorder type in which the data are stored on a digital storage device with mobile part(s). “Digital storage device with mobile parts” designates any digital data storage system in which at least one element is moving towards a storage area, as opposed to motionless storage systems like integrated circuit memories. It may be, for example, a magnetic or optical write disk.

A disadvantage of digital video recorders with disk(s) is linked to the fragility of the data storage disk (generally a hard disk). Disks of the type used in computers, which are housed in a protective covering aiming at damping shocks, are generally used. However, such conventional protections are notoriously insufficient for a portable sound or video recorder. This is especially why disk digital video recorders are most often so-called “deckstop” devices.

It would be desirable to take advantage of the digital storage on disk and especially on the storage capacity-to-volume ratio in portable sound recorders. In particular, in applications to so-called professional or multitrack sound recorders, the separate recording of the different tracks makes digital storages particularly advantageous. Now, this type of sound recorder is most often used for outdoor sound recording (for example, in film shootings).

### SUMMARY OF THE INVENTION

The present invention aims at providing a portable sound recorder on digital disk(s).

The present invention more specifically aims at providing a shock-resistant device, that is, in which a shock received by the device does not risk damaging the storage support.

More generally, the present invention aims at providing a digital sound and/or image digital recording device with a digital storage device having (a) mobile part(s).

The present invention also aims at providing a low-bulk device which is easy to use.

The present invention also aims at providing a device which can be used both as a portable device and as a table device.

To achieve these and other objects, the present invention provides a portable sound or image recording device comprising:

a body comprising recording elements, control elements and input-output sockets,

two legs each formed of a supply element for powering the device, said legs being removably assembled by means of damping elements on said body in the vicinity of its ends to define a portico; and

a package laterally framed by the respective legs and intended to contain at least one digital storage device with a mobile part, the height and the width of the legs being such that the package inscribes within said portico.

According to an embodiment of the present invention, said package is defined by an extension of the body between said legs.

According to an embodiment of the present invention, the digital storage device is attached to the package by damping elements.

According to an embodiment of the present invention, said digital storage device is attached to a cap of the package by damping element, said cap being attached to a bottom of said package by a resilient connection.

According to an embodiment of the present invention, input/output sockets are arranged in a recess of a front and/or rear surface of the body, the package being set back with respect to the input/output sockets.

According to an embodiment of the present invention, the input/output sockets are inclined with respect to the vertical plane of the device.

According to an embodiment of the present invention, the supply elements are hung to the body by connectors combining the function of a damper and of an electric connection.

According to an embodiment of the present invention, the digital storage device is connected to the body package, mechanically exclusively by resilient elements, and electrically exclusively by wire connections.

According to an embodiment of the present invention, the body contains an electronic board extending in the package, with no direct contact with the digital bearer.

According to an embodiment of the present invention, the weight of the supply elements is chosen to ballast the device to force a possible fall in the vertical position.

The foregoing objects, features and advantages of the present invention will be discussed in detail in the following non-limiting description of specific embodiments in connection with the accompanying drawings.

### BRIEF DESCRIPTION OF THE DRAWINGS

FIG. 1 shows in perspective a front view of a device according to an embodiment of the present invention;

FIG. 2 shows in perspective a back view of the device of FIG. 1;

FIG. 3 is a transversal cross-section view of the device of FIGS. 1 and 2; and

FIG. 4 is a partial perspective view of the device laid flat.

### DETAILED DESCRIPTION

Same elements have been designated with same reference numerals in the different drawings. For clarity, among the shown elements, only those elements of the device which are useful to the understanding of the present invention will be discussed in detail. In particular, the different command, control, and socket organs, the positions and functions of which are not specified as belonging to the present invention may be omitted, moved or replaced. Further, elements which are not useful to the understanding of the present invention have not been shown and will not be detailed. In particular, the internal structure of a digital disk storage system has not been detailed and is no object of the present invention. Only its conventional protection covering has been shown. Similarly, the different internal components and integrated circuits enabling storage have not been detailed, since they are perfectly conventional.

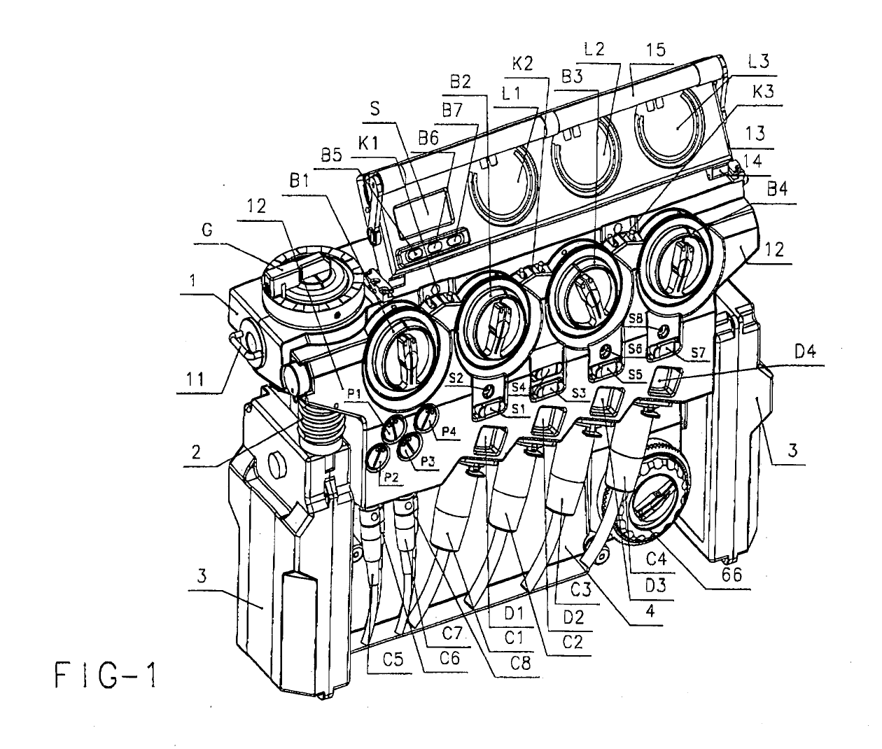

FIG. 1 is a perspective view from the front of the device. “Front” or “front surface” of the device designates the surface thereof which forms the top surface of the device when said device is laid on a table and which is intended to be accessible by the user when he carries the device slung across his shoulder, that is, the surface opposite to that resting against the user's body.

A body 1 contains or supports most of the components or elements necessary to the recording (except for the digital data storage). To this body 1 are connected, laterally on either side, by resilient damping systems 2, two supply elements 3. These may be two autonomous supply batteries or a battery and a power converter intended to be connected to the electric supply mains. Lateral elements 3 aim at ballasting the device and protecting a package 4 containing at least one digital storage disk 41. Preferably, package 4 (and thus the storage disk (s)) is an extension of body 1 between elements 3. As an alternative, the package is hung to the body also by resilient dampers. Unless otherwise mentioned, the on-disk storage system, comprising the disk(s) and their conventional protective covering as well as their control circuits conventionally comprised in this covering, is designated as “disk” 41.

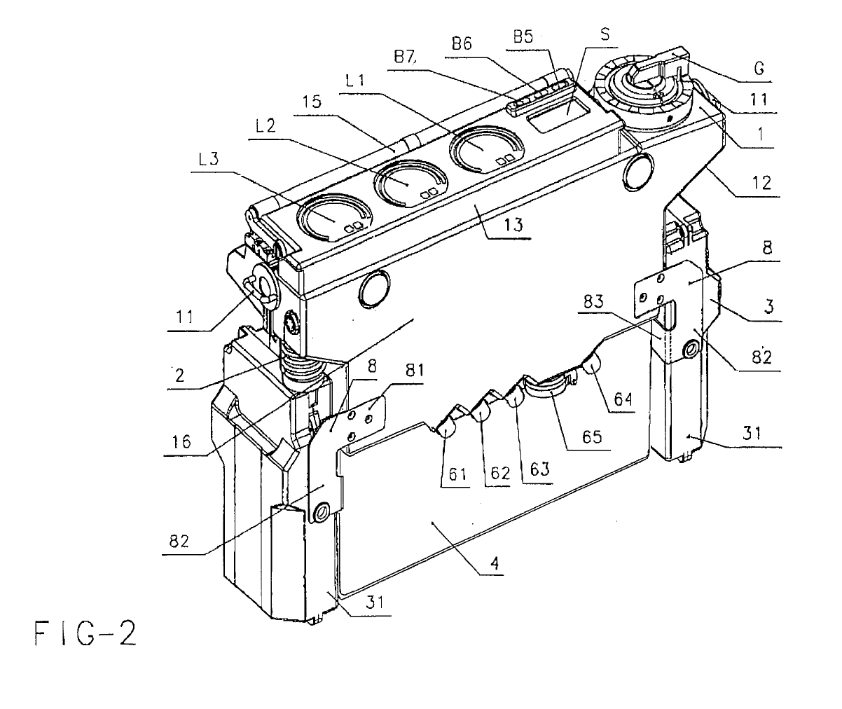

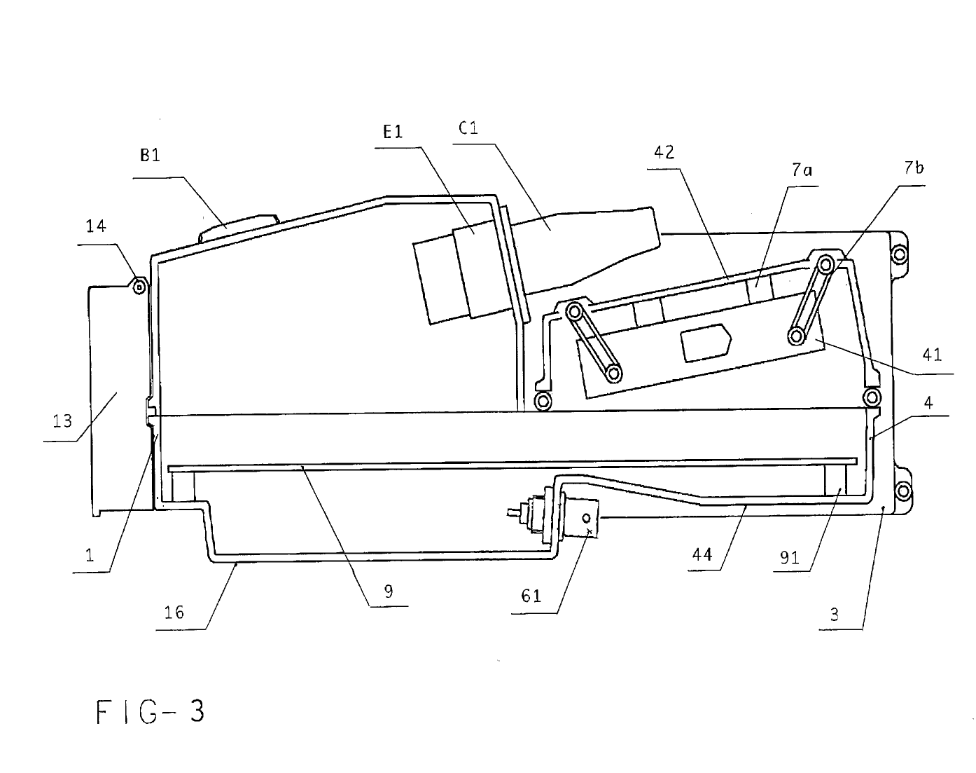

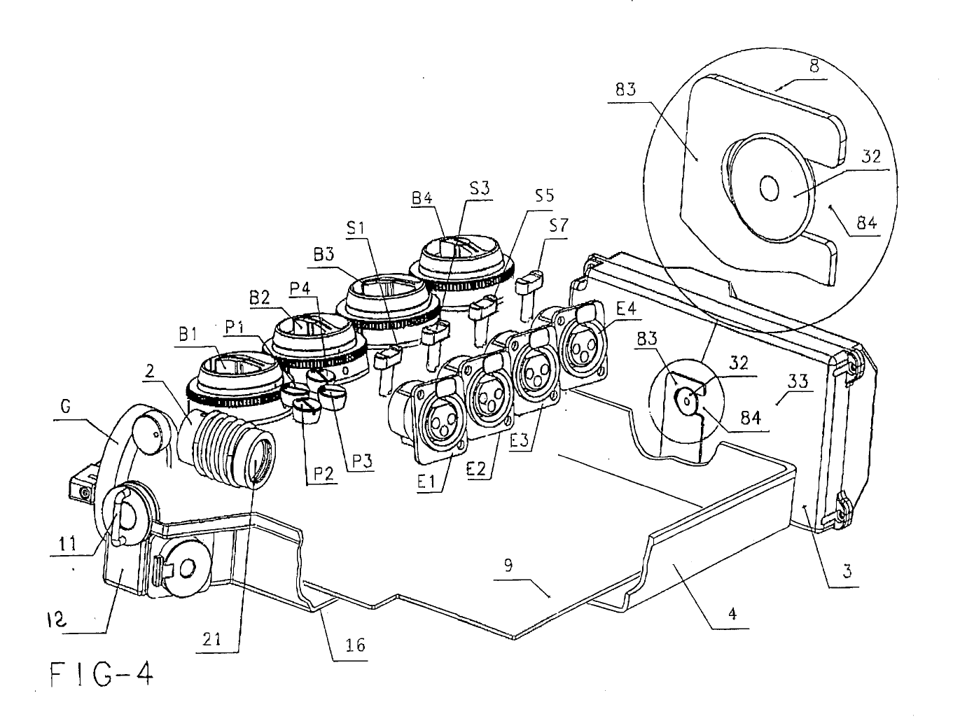

FIG. 2 is a rear perspective view of the device in vertical position and FIG. 3 is a transversal cross-section view. FIG. 4 is a partial perspective view of the device in which not all elements have been shown to better show the details which will be described hereafter.

A feature of the present invention is to connect, by vibration damping elements 2, lateral elements 3 to body 1. Another feature of the present invention is to house disk 41, and more specifically package 4 defined by the extension of body 1, in the space between the lateral elements. Batteries 3 form, in a way, the legs of a portico, the crosspiece of which corresponds to the upper part of body 1.

As better appears from FIG. 3, disk 41 is hung by damping elements 7 to cap 42 of package 4, bottom 44 of which preferably corresponds to an extension of bottom 16 of body 1 off-set to the inside of the device.

Another feature of the present invention is to use the power system (battery and/or converter) to both protect the disk against lateral shocks and take shocks in case of a fall. According to the present invention, the power system, which has the advantage of being formed of heavy elements, is used to ballast the device. This further has the advantage, in case of a fall, of forcing the device to orient itself in a vertical fall, legs down. The buttons and dials of the device arranged on body 1 are thus indirectly protected. Further, the shock is transmitted to body 1 by dampers 2 of connection to batteries 3, before being transmitted, by dampers 7a and 7b (hereafter commonly designated by reference 7 for simplicity), from package 4 to disk 41. Dampers 7 are additional to conventional systems provided between the actual disks and the covering in which they are housed and which is connected, by dampers 7, to cap 42. Preferably, the link between cap 42 and bottom 44 of package 4 is resilient. So, cap 42 (and disk 41) is not rigidly coupled to parts 1 and 4. The disk protection against vertical shocks is thus considerably improved.

Of course, the batteries (or their respective packages) have a height such that, once in place, package 4 can no longer rest on the ground or on a table if the device is set upright.

Further, the functional (electric) connections of disk 41 to package 4 and to body 1 are wire connections to avoid annihilating the effects of the mechanical protection by dampers 7. Any conventional series or parallel link connection may be used, for example, by means of layers of flexible conductors (not shown). Similarly, the electric connections of batteries 3 to body 1 are either wire connections or, according to a preferred embodiment, integrated in rigid connectors 21 (FIG. 4) in damping elements 2. Elements 3 are removably assembled to enable changing of the batteries if need be.

To stabilize the batteries or other powering elements, trihedral flat stirrups 8 rigidly attached to body 1 and connected with a vertical play to batteries 3 are preferably provided. A first branch 81 of each stirrup 8 is attached to rear surface 16 of body 1 of the device. A second branch 82 is parallel to a rear surface 31 (in position on the device) of the corresponding battery. A third branch 83 comprises a port 84 (FIG. 4) open downwards and in which slides a stud 32 protruding from an internal surface 33 of the corresponding battery. The Function of port 84 is to prevent a rigid connection, at least in the vertical direction, between the battery and the body, which would annihilate the effect searched by dampers 2. Of course, stud 32 can be attached to stirrups 8 and part 84 can be provided in a wall of the battery.

As an alternative, in additions to dampers 2, any resilient connection between batteries 3 and body 1 may be provided (for example, by means of flexible stirrups attached on either side).

An electronic board 9 (FIGS. 2 and 3) comprised in the upper part of body 1 may have extend out of it due to the number of components that it supports. In this case, it is provided for board 9 to be able to extend into package 4 of disk 41, said card having however no rigid contact with disk 41. Card 9 is attached to body 1 (fastenings 91, FIG. 3) and extends parallel to rear surface 16. Such an embodiment contributes to the device miniaturization without adversely affecting the shock-damping concept. An electronic board (not shown) supporting integrated circuits for controlling disk 41 may also be housed in package 4.

To be carried slung across the shoulder, body 1 comprises, for example, on either side, tabs 11 for receiving a shoulder strap (not shown).

In the example shown, the shape given to body 1 is such that batteries 3 once in place remain within the surface bulk of body 1 as seen from above. Connectors 2 are then provided under lateral shoulderings 12 of body 1. Other shapes may of course be envisaged. According to the preferred embodiment of the present invention, the entire device inscribes within a rectangular block which, in upright position (slung across the shoulder) is wider than it is high and higher than it is thick, like a conventional portable device.

In the shown example of a multitrack sound recorder, four main inputs E1 to E4 (FIG. 4) are provided in the form of standard adapted sockets. With each input is associated a potentiometer for setting level B1 to B4 at the front surface to be easily accessible by the user.

The position of sockets E1 to E4 is characteristic of the preferred embodiment of the present invention. First, these sockets are arranged in a recess of the front surface of body 1 and are directed downwards, so that once wires cables C1 to C4 (FIG. 1) of connection to the sound sensors (microphones or the like) are connected, these cables cover package 4. The position of package 4 is thus set back with respect to the front surface of the device. Thus, package 4 (and thus disk 41) is protected by the cables when the user carries the device slung across his shoulder. Second, the sockets are inclined with respect to the vertical connection plane to ease the cable exit when the device is laid vertically on the ground or on a table while cables are plugged. Preferably, each socket E1 to E4 is associated with a finger grip D1 to D4 (FIG. 1) easing the actuation of conventional elements for catching plugs in the sockets.

Other command, control and plugging elements are present on body 1. The positions, shapes and functions of these elements are conventional and will not be detailed. A large number of elements has been shown and will be listed hereafter, at least partially, to illustrate that the device of the present invention, although exhibiting a reduced surface area as compared to conventional devices for receiving the different buttons, lights, sockets, etc. may receive on its body all desirable command, control, and socket elements. These elements are connected inside (not shown) of the body, conventionally, to the corresponding circuits. Thus, as illustrated in the different drawings, the multitrack sound recorder visibly shown comprises:

At its front surface:

four potentiometers P1 to P4 for setting the level of four auxiliary sockets E5 to E8 accessible from the bottom of body 1 (cables C5 to C8) like sockets E1 to E4 of the main inputs; and

selection switches S1 to S8.

At its upper surface:

a general setting button G;

switches K1 to K3; and

a display panel 13 comprising three level indicators L1 to L3, a rectangular display S, and three buttons B5 to B7.

According to a preferred embodiment of the present invention, panel 13 rotates around a Longitudinal axis 14 (FIGS. 1 and 3) between a so-called closed position (FIG. 2) where it is parallel above body 1, and a so-called open position (FIG. 1) where it is almost parallel to the front surface of the device. The closed position enables the user to easily visualize the displays when he carries the device slung across his shoulder or when the device is set upright. The open position enables easy visualization of the displays when the device is laid on a table.

Preferably, panel 13 is associated with a longitudinal lighting bar 15 articulated with respect to the panel.

Still according to a preferred embodiment, sound recorder managing elements (designated with reference numerals 61 to 66), for example, digital input/output sockets 61 to 64 (FIG. 2), and a connector 65 (FIG. 2) are provided on the rear side of the package 4, and a selector 66 (FIG. 1) is for example, integrated to package 4. The different accessories are, preferably and especially for input/output sockets, oriented towards the bottom of the device to be easily accessible and are disposed in the shoulder between bottoms 16 and 44. According to this embodiment, cables (not shown) connected to sockets 61 to 64 and to connector 65 contribute to the protection of the rear side of the device. Further, the input/output sockets are raised from the floor when the device is set upright.

It should be noted that the rear surface of the device is protected by the user's body against which it rests when the device is carried slung across his shoulder, and by the table or the support on which the device rests when laid flat.

Of course, the present invention is likely to have various alterations, modifications, and improvements which will readily occur to those skilled in the art. In particular, although the present invention has been described in relation with a multitrack sound recorder, it more generally applies to any portable sound and/or image recording device on a support with (a) mobile part(s).

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A portable sound or image recording device comprising:
a body (1) comprising recording elements, control elements and input-output sockets;
two legs each formed of a supply element (3) for powering the device, said legs being removably assembled by means of damping elements (2) on said body in the vicinity of its ends to define a portico; and
a package (4) laterally framed by the respective legs and intended to contain at least one digital storage device (41) with a mobile part, the height and the width of the legs being such that the package inscribes within said portico.

2. The device of claim 1, wherein said package (4) is defined by an extension of the body (1) between said legs.

3. The device of claim 1, wherein the digital storage device (41) is attached to the package (4) by damping elements (7).

4. The device of claim 1, wherein said digital storage device (41) is attached to a cap (42) of the package by damping element (7), said cap (42) being attached to a bottom (44) of said package by a resilient connection.

5. The device of claim 1, wherein input/output sockets (E1, E2, E3, E4) are arranged in a recess of a front and/or rear surface of the body (1), the package (4) being set back with respect to the input/output sockets.

6. The circuit of claim 5, wherein the input/output sockets (E1, E2, E3, E4) are inclined with respect to the vertical plane of the device.

7. The device of claim 1, wherein the supply elements (3) are hung to the body (1) by connectors (2) combining the function of a damper and of an electric connection.

8. The device of claim 1, wherein the digital storage device (41) is connected to the package (4) of the body (1), mechanically exclusively by resilient elements (7), and electrically exclusively by wire connections.

9. The device of claim 1, wherein the body (1) contains an electronic board (9) extending in the package (4), with no direct contact with the digital storage device (41).

10. The device of claim 1, wherein the weight of the supply elements (3) is chosen to ballast the device to force a possible fall in the vertical position.
